(19) United States
(12) Patent Application Publication
(10) Pub. No.: US 2026/0090565 A1
(43) Pub. Date: Apr. 2, 2026

(54) METHODS AND FORMULATIONS FOR CREATING AND PRESERVING A UNIQUE TEXTURE AND CHEWINESS OF STARCH-BASED CHEWY CANDIES AND ASSOCIATED FORMULATIONS

(71) Applicant: The Stardust Food Company, Bethesda, MD (US)

(72) Inventors: Michelle Schwenk, Decatur, IL (US); Kjetil Hansen, Bethesda, MD (US); Mika Shino, Bethesda, MD (US)

(21) Appl. No.: 18/903,797

(22) Filed: Oct. 1, 2024

(51) Int. Cl. A23G 3/42; A23G 3/34; A23G 3/44; A23G 3/54

(52) U.S. Cl. CPC A23G 3/42; A23G 3/0021; A23G 3/44; A23G 3/54

(57) ABSTRACT

Provided herein are methods and formulations for Creating and Preserving a Unique Texture and Chewiness of Starch-Based Chewy Candies and Associated Formulations. This formulation and method of manufacturing processes comprise an improvement in texture, chewing experience, and in shelf stability of a starch-based consumer packaged food (a.k.a. “gummy candy”). The methods and formulations comprises an unexpected and unique texture and chew in a shelf-stable starch-based candy.

### BACKGROUND

The invention generally relates to a formulation and method for creating a formulation, where the end product is a gummy candy which preferably has an especially (and atypically) soft texture with an extended shelf life over that of the prior art and is formed of ingredients which preferably results in the end product being animal product and byproduct free (i.e., gelatin free or free of animal-based gelatin).

Plant-based and shelf-stable chewy candies have remained a challenge to formulate and manufacture. Traditional gummy candies such as gummy bears often use gelatin to provide the familiar bite, chewiness, and shelf-stability required as a consumer packaged good (CPG). However, gelatin is typically produced by the hydrolysis of collagen extracted from the connective tissue of animals such as cattle, chicken, pigs and fish, a major constraint for those who prefer plant-based diets due to personal or religious preferences.

Gummy candies made from starch flours typically become hard, chalky, or brittle when kept at room temperature for extended periods thereby adversely impacting shelf life, consistency, texture, and taste. Instead of the soft bouncy texture of gummy bears, traditional starch-based candies have a tougher bite and shorter chew, as characterized by licorice-type candies such as Twizzlers®, Red Vines®, or hard and tooth sticking candies like Swedish Fish® or Sour Patch Kids®. This hardened texture is due to a process called retrogradation (see below), where the amylose and amylopectin components of gelatinized starch reorganize into a more crystalline structure, resulting in a firmer and less palatable texture. To formulate a softer chew where the chew and shelf life preserved over time, it is important to minimize retrogradation.

Soft textures and elastic chews are often observed in starch-based candies immediately after cooking (i.e., heating in the presence of water), but they are difficult to preserve over time, even with the use of artificial preservatives. The preservatives traditionally used in starch-based candies include: sodium benzoate, potassium sorbate, sorbic acid, isopropyl alcohol, among others, with many having questionable health effects. The gummy candy category continues to grow, but retrogradation and the reliance on traditional preservatives, and manufacturing methods has limited the textures and chews available in the starch-based animal-free (i.e., gelatin-free) chewy candy segment.

The present invention attempts to solve these problems, as well as others.

### SUMMARY OF THE INVENTION

Provided herein are methods and formulations for Creating and Preserving a Unique Texture and Chewiness of Starch-Based Chewy Candies and Associated Formulations. This formulation and method of manufacturing processes comprise an improvement in texture, chewing experience, and in shelf stability of a starch-based consumer packaged food (a.k.a. “gummy candy”). The methods and formulations comprises an unexpected and unique texture and chew in a shelf-stable starch-based candy.

The methods and formulations are set forth in part in the description which follows, and in part will be obvious from the description, or can be learned by practice of the methods and formulations. The advantages of the methods and formulations will be realized and attained by means of the elements and combinations particularly pointed out in the appended claims. It is to be understood that both the foregoing general description and the following detailed description are exemplary and explanatory only and are not restrictive of the methods and formulations, as claimed.

Accordingly, it is an object of the invention not to encompass within the invention any previously known product, process of making the product, or method of using the product such that Applicants reserve the right and hereby disclose a disclaimer of any previously known product, process, or method. It is further noted that the invention does not intend to encompass within the scope of the invention any product, process, or making of the product or method of using the product, which does not meet the written description and enablement requirements of the USPTO (35 U.S.C. § 112, first paragraph) or the EPO (Article 83 of the EPC), such that Applicants reserve the right and hereby disclose a disclaimer of any previously described product, process of making the product, or method of using the product. It may be advantageous in the practice of the invention to be in compliance with Art. 53(c) EPC and Rule 28(b) and (c) EPC. All rights to explicitly disclaim any embodiments that are the subject of any granted patent(s) of applicant in the lineage of this application or in any other lineage or in any prior filed application of any third party is explicitly reserved. Nothing herein is to be construed as a promise.

### BRIEF DESCRIPTION OF THE DRAWINGS

In the accompanying figures, like elements are identified by like reference numerals among the several preferred embodiments of the present invention.

FIG. 1 is a schematic of a glycerin molecule with three hydroxyl (—OH) groups. [3]

FIG. 2 is a graph showing the viscosity measurement of starch in an excess amount of water, applying a temperature profile including a heating and cooling step. (1) Gelatinization onset (TP, pasting temperature), (2) hydration of starch granules, (3) max. intensity of gelatinization (PV, peak viscosity), (4) enzymatic and shear destruction of starch granules, (5) minimum viscosity (HPV, hot paste viscosity), (6) viscosity loss (B, breakdown), (7) final viscosity (FV), and (8) paste hardening (S, setback). [4]

FIG. 3 is a molecular structure of hydrogen bonding between water and starch molecule. [5]

FIGS. 4A-4D are molecular structures of sorbitol, erythritol, xylitol and mannitol with hydroxyl (—OH) groups. [6,7,8,9]

FIG. 5 is a schematic of a scraped surface heat exchanger.

FIG. 6 is a schematic of a single screw cooker/extruder.

### DETAILED DESCRIPTION OF THE INVENTION

The foregoing and other features and advantages of the invention are apparent from the following detailed description of exemplary embodiments, read in conjunction with the accompanying drawings. The detailed description and drawings are merely illustrative of the invention rather than limiting, the scope of the invention being defined by the appended claims and equivalents thereof.

Embodiments of the invention will now be described with reference to the Figures, wherein like numerals reflect like elements throughout. The terminology used in the description presented herein is not intended to be interpreted in any limited or restrictive way, simply because it is being utilized in conjunction with detailed description of certain specific embodiments of the invention. Furthermore, embodiments of the invention may include several novel features, no single one of which is solely responsible for its desirable attributes or which is essential to practicing the invention described herein.

The use of the terms “a” and “an” and “the” and similar referents in the context of describing the invention are to be construed to cover both the singular and the plural, unless otherwise indicated herein or clearly contradicted by context. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Recitation of ranges of values herein are merely intended to serve as a shorthand method of referring individually to each separate value falling within the range, unless otherwise indicated herein, and each separate value is incorporated into the specification as if it were individually recited herein. The word “about,” when accompanying a numerical value, is to be construed as indicating a deviation of up to and inclusive of 10% from the stated numerical value. The use of any and all examples, or exemplary language (“e.g.” or “such as”) provided herein, is intended merely to better illuminate the invention and does not pose a limitation on the scope of the invention unless otherwise claimed. No language in the specification should be construed as indicating any nonclaimed element as essential to the practice of the invention.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

This disclosure describes a plurality of innovations, all relevant to the end product of a shelf-stable, starch-based gummy candy that provides an unexpected, positive, and unique soft bouncy texture and long elastic chew that is sustained for longer periods of time (months) at room temperature, thereby substantially improving the eating experience. The following sections describe these innovations.

### Description of Embodiments

Generally speaking, a formulation and method for creating a formulation comprises an end product is a gummy candy which preferably comprises an atypical soft texture with an extended shelf life over that of the prior art and is formed of ingredients which preferably results in the end product being animal product and byproduct free (i.e., gelatin free or free of animal-based gelatin). This formulation and method of production comprising a shelf-stable starch-based gummy candy allows for an unexpected and unique bouncy soft-texture and elastic chew, that is self-sustained for longer periods of time (months) with decreased degradation in consistency, texture, or taste, thereby substantially improving the eating experience for consumers, as well as the shelf storage life.

In one embodiment, the method and formulation comprises polar molecules such as polyols (e.g., glycerin, sorbitol, erythritol, xylitol, and mannitol) into a starch-based gummy candy formulation, resulting in polyol binding to the starch molecules, and thereby improving gelatinization and decreasing retrogradation. Starch gelatinization is the process of breaking down the molecular bonds of starch in the presence of water and heat, leading to starch granule swelling, granule rupture and release of the amylose and amylopectin components of starch from the granule into the surrounding water. Starch gelatinization produces the textures and consistency of many starch-based food such as pasta, rice, and bread. Starch retrogradation is the process where the amylose and amylopectin components of gelatinized starch reorganize into a more crystalline and harder structure.

Through extensive testing of numerous formulations, the method and formulation comprises polyols to improve gelatinization of starch-based candies and to reduce retrogradation compared with the prior art, resulting in a surprising soft, chewy, and shelf-stable gummy candy. Furthermore, the method comprises combining polyols with select starches and starch combinations, among other ingredients, to achieve a texture and chewiness that is unique among existing chewy candies. The result was surprising and unexpected in the examples below.

In one embodiment, the method and formulation comprises one or more starches in combination with the polyol glycerin to create the desired texture, chew, and shelf-stability. Typical starch-based candies that do not use gelatin are often hard, with a tough bite and a shorter chew (e.g., Twizzlers®, Red Vines®, Swedish Fish®) due to starch retrogradation. The incorporation of polyol molecules into the starch gives a uniquely soft bouncy texture with a more elastic chew compared with prior art starch-based candies.

In extensive bench top trials, an unexpected interaction between several different polyol molecules (including but not limited to glycerin, sorbitol, erythritol, xylitol, and mannitol) and different starches (including but not limited to rice, tapioca, arrowroot, corn, potato, and taro) were demonstrated to substantially improve the gelatinization and retrogradation profile of the starch. The extent of gelatinization and retrogradation over time are key aspects determining the ultimate texture, chew, and shelf-stability of starch-based candies. The method and formulation comprising polyol molecules prevented the starches from becoming hard, chalky, brittle, or moldy at room temperature for prolonged periods of over 6 months and provided a soft bouncy texture and elastic chew that is unique among existing candies.

In another embodiment, the method and formulation comprises the use of starch combinations to create the desired texture, chew, and shelf-life of the gummy candy. Through the use of combinations of modified and unmodified starches from different sources including but not limited to rice, tapioca, arrowroot, corn, potato, and taro, the method enhances specific desired qualities including softness, bounce, chewiness, elasticity, and shelf-life to improve the eating experience for consumers over candies presently available. Each of these starches has differences in terms of the flavor, color, pH, water solubility, and amylose vs. amylopectin content. A higher amylopectin to amylose content ratio improves gelatinization and decreases retrogradation. Similarly, the modification of these starches (e.g., through acetylation or esterification) also facilitates gelatinization and reduces retrogradation. Thus, the incorporation of these starch types in combination allows us to control specific qualities including flavor, color, softness, bounce, chewiness, mouthfeel, elasticity, and shelf-life compared with candies presently available.

Another embodiment, the method of manufacture of starch-based formulations comprises using a refined cooking process involving a combination of temperature, mechanical stress, and/or pressure for the purpose of creating the desired final texture, chew, and shelf stability. In addition to heat, pressure improves hydration of the starch granules, while mechanical shear improves starch granule disruption. The production methods comprising temperature, mechanical stress, and pressure and substantially improving the texture and chew of the product and minimized retrogradation or staling. This production method comprises using specific machinery including: 1) a novel pressurized scraped surface heat exchanger, and/or 2) single or twin-screw cooking extruder.

Thus, the method and formulation comprises a food product containing a combination of 5-40% starch (rice, tapioca, arrowroot, corn, potato, and/or taro), 0.1 to about 15% polyol (e.g., glycerin, sorbitol, erythritol, xylitol and mannitol.), 30-80% saccharide (mono-, di-, oligo- and polysaccharides), flavor, and color, among other ingredients. In addition to the incorporation of polyols to the formulation, the method and formulation uses starch combinations, and a production process involving heat, shear, and pressure to result in a unique and prolonged soft chewy texture that is concurrently stable against becoming hard, brittle, or moldy.

In one embodiment, we disclose one or more novel starch-based gummy candy formulations characterized by inclusion of one or more forms of polyol alcohol (“polyol”) molecules (e.g., glycerin, sorbitol, erythritol, xylitol, and mannitol) with one or more starches (e.g., rice, tapioca, arrowroot, corn, potato, and taro). These molecules at least in part unexpectedly serve to improve gelatinization and reduce retrogradation of starches, thereby increasing the candy's softness, bounce, bite, chew, and shelf-stability, with a preserved texture over at least about 6-12 month period. This embodiment allows for the production of shelf-stable starch-based chewy gummy candies without the use of gelatin or traditional preservatives (e.g., sodium benzoate, potassium sorbate, sorbic acid, isopropyl alcohol) that are commonly found in contemporary chewy candies. That is, the present invention is directed to a starch-based chewy candy without the use of either gelatin or animal-based gelatin products.

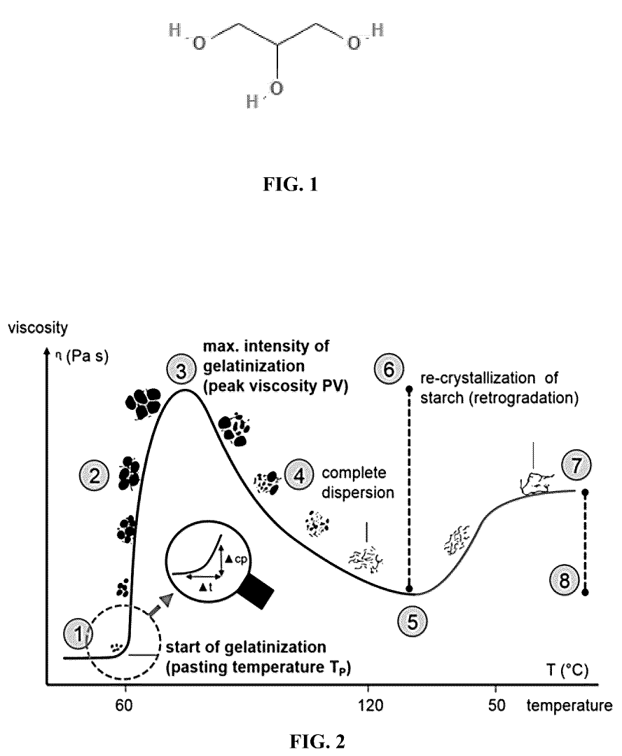

Glycerin (a.k.a., glycerol, glycerine) is a naturally occurring polyol that is colorless, odorless but sweet tasting. It is a small molecule consisting of a three-carbon chain with three hydroxyl groups [FIG. 1]. The glycerin 3 carbon backbone is found naturally in lipids known as glycerides (e.g., triglycerides) and the hydrolysis, saponification, or transesterification of these triglycerides produces glycerin as well as fatty acid derivatives. There are many plant sources of glycerin including: soybean, coconut, sunflowers and palm. Animal sources include tallow (rendered beef fat) and lard (rendered pork fat). Glycerin can also be produced synthetically, although the high cost often make synthesis economically prohibitive. The method and formulation is preferably totally free of any animal products. The use of glycerin derived from plant sources allows us to capture the beneficial properties of this polyol, while keeping the candy animal byproduct free. That is, the method and formulation is further directed to a starch-based chewy candy without use of animal products or byproducts.

In food and beverages, glycerin is often used as a humectant, solvent and sweetener. It is a carbohydrate with approximately 27 kilocalories per teaspoon (kilocals/teaspoon) and has about 60% of the sweetness of sucrose. The U.S. Food and Drug Administration (FDA) has approved glycerol for use as a food additive and is generally recognized as safe (GRAS) for human consumption. [1]

Starch gelatinization is the process of disrupting the intermolecular bonds of starch molecules in the presence of water and heat, allowing the hydrogen bonding sites (i.e., the hydroxyl hydrogen and oxygen atoms) of the starch to engage with more water. This leads to: 1) starch granule swelling, 2) disruption of starch double helical structures, and 3) starch granule rupture (FIG. 2). Gelatinized starch, when cooled or stored for a long enough period (hours to days) will harden and rearrange itself again to a more crystalline structure in a process known as retrogradation. This reorganization or retrogradation is the major factor leading to the hard, chalky, or brittle characteristics that most starches including rice and tapioca starches develop at room temperature.

The extent and timing of starch gelatinization and retrogradation is dependent on a number of factors including starch solubility, water content, amylose vs amylopectin content (described below) and cooking conditions. The water-to-starch ratio is a critical factor for starch-based candies. Due to water's ability to engage with starch hydrogen bonding sites, higher water-to-starch ratios increase starch granule swelling, granule rupture, and gelatinization. However, the water content of the final product must be maintained below strict levels to ensure protection against the growth of bacteria and mold during and after the cooling process.

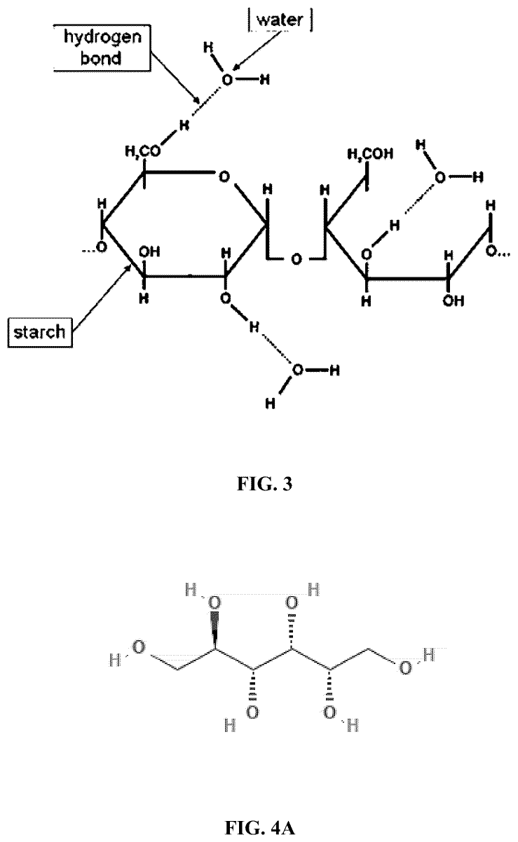

After extensive testing of hundreds of ingredients and formulations, select polyols have a unique and unexpected interaction with select starches to improve gelatinization, minimize retrogradation and inhibit bacterial and mold growth. This occurs due to the polar hydroxyl groups of the polyol molecules. Similar to water, these polyol hydroxyl groups are available for bonding with starch molecules (e.g., hydrogen bonding) thereby disrupting starch to starch intra and intermolecular bonding (FIG. 3). Thus, polyols such as glycerin are able to engage with starch to disrupt the starch's molecular order and facilitate granule rupture, gelatinization and decrease retrogradation, importantly without increasing the water content of the final product.

This embodiment allows for the production of a shelf-stable gummy that is preserved for months without becoming hard or chalky, and while protecting against bacterial and mold growth. Further, by facilitating gelatinization these polyol molecules substantially improve the soft, bouncy, and chewy texture of the gummy. This unique texture is preserved over months without becoming hard, chalky, or brittle due to decreased retrogradation. Consequently, at least both shelf life and texture are improvements over prior art. That is, the method and formulation is further directed to a starch-based chewy candy improved shelf life and texture.

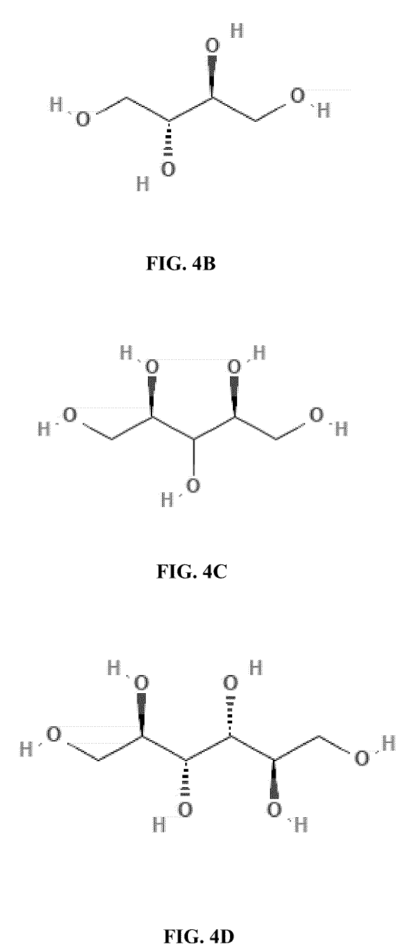

In addition to glycerin, other polyol molecules including sorbitol, erythritol, xylitol, and mannitol (FIGS. 4A-4D) were tested in benchtop trials and these molecules also improved the texture, chew, and shelf-stability of the gummy candy, but to varying degrees. Each of these molecules produced a uniquely different profile in terms of softness, bounce, bite, chew, and stability, and the overall improvement in eating experience was greatest for the glycerin. Each of these polyol molecules is unique in their ability to improve specific gummy candy qualities.

After testing hundreds of formulations with staling and molding trials lasting 3-6 months, the incorporation of all of these polyols into starch-based gummy candies improved gelatinization, delayed retrogradation, and inhibited bacterial and mold growth. These polyols also improved the chewy texture of the gummy and this unique chew was preserved over months without becoming hard, chalky, or brittle.

Another embodiment comprises using the starch combinations to create a desired texture, chew, and shelf-life of the gummy candy. Through the use of various starches obtained from rice, tapioca, arrowroot, corn, potato, and taro, in combination, the method and formulation selects and enhances specific desired qualities including softness, bounce, chewiness, elasticity, and shelf-life in the combination of formulation and manufacture so as to improve the eating experience for consumers over candies presently available. Each of these starches have differences in terms of the flavor, color, water solubility, pH, and amylose vs. amylopectin proportions (Table 1 [2]). The incorporating of these starch types in combination allows us to control specific qualities including the texture, chew, mouthfeel and shelf-life of the final product.

TABLE 1
Amylose and amylopectin content of starch from different sources.

| Type of starch | Amylose (%) | Amylopectin (%) |
|---|---|---|
| Amylomaize | 48-77 | 23-52 |
| Banana | 17-24 | 76-83 |
| Corn | 17-25 | 75-83 |
| High-amylose corn | 55-70 | 30-45 |
| Potato | 17-24 | 76-83 |
| Rice | 15-35 | 65-85 |
| Sorghum | 25 | 75 |
| Cassava | 19-22 | 28-81 |
| Wheat | 20-25 | 75-80 |
| Waxy | <1 | >99 |
| Yam | 9-15 | 85-91 |

For example, tapioca starch has more amylopectin compared with rice starch which has a combination of amylopectin and amylose. Amylopectin is a highly branched polysaccharide due to α(1→6) glycosidic bonds at branch points occurring at every 24-30 glucose units. Amylose is mostly a linear polysaccharide due to α(1→4) glycosidic bonds. Amylopectin's highly branched structure allows water and heat to penetrate the granules more easily, facilitating granule swelling and rupture. Thus, amylopectin is easier to hydrate, will gelatinize at a lower temperature and will have less retrogradation compared with amylose. Amylopectin's extensive side chains also produces a soft and elastic texture, compared to the firm and compact texture of amylose.

The ways to measure softness, bounce, bite, chew, and stability of the food product include texture profile analysis, which uses a machine like the TAXT2 from Stable Microsytems. Texture profile analysis compress the sample 40%, releases the pressure, compress the sample 40% again. The procedure first press is hardness, ratio of distance to max firmness for each compression is chewiness, amount of pull back is stickiness (adhesiveness), area underneath the second compression curve divided by the area underneath the first compression curve is cohesiveness, resilience (elasticity) ratio of the area of the curves. Normal starch candy is cohesive, sticky (adhesive) and not elastic, and the current starch gel embodiments are less sticky and more elastic. A TPA analysis on both will show an increase in elasticity and decrease in stickiness of the starch-based food products of the present invention.

Starch is made from amylose and amylopectin which add to =100% starch. Tapioca is about 17% amylose and about 85% amylopectin. Rice: short grain is about 24% amylose, about 76% amylopectin. Dent Corn starch is about 27% amylose, and about 73% amylopectin. High Amylose corn starch: used in confections industry to increase gelling is between about 55 to about 70% amylose. Potato Starch is about 20% amylose and about 80% amylopectin. A method for measuring amylose content is disclosed in “A Simplified Chemical Method for Determining Classes of Rice Amylose Content which Control Cooked Rice Texture” by Dr. Ming-Hsuan Chen at USDA Agricultural Research Service.

The use of modified starches by various methods (e.g. acetylation, esterification, etc.) also comprises a gelatinization and retrogradation profile. The addition of acetyl or ester groups to the starch molecule has the same effect as amylopectin side chains, making these starches easier to hydrate, gelatinize with decreased retrogradation. Through the use of these starch combinations (e.g., modified vs unmodified, tapioca, rice, arrowroot, corn, potato, and taro), the method and formulation controls the proportion of ruptured or “pasted” starch granules in their gelatinized state vs. intact “unpasted” starch granules in their native state, in another embodiment. This ratio of pasted vs. unpasted starch granules substantially affect the texture, chew and mouthfeel of the candy. Thus, the use specific starch and starch combinations improves specific qualities including softness, bounce, chewiness, mouthfeel, elasticity, and shelf-life compared with candies presently available. The method and formulation comprises the incorporation of water and polyols to modified starches producing a novel texture to the candy that has not previously been produced. This is due to the properties of the unique gel that is formed by the modified starch, water and polyol matrix. This novel gel embodiment is also more stable since it retrogrades at a slower rate. Another embodiment is the method of manufacturing comprising using a cooking process involving temperature, mechanical stress, and/or pressure, resulting in improved texture, chew and shelf-life of starch-based gummy candies. Traditional starch-based gummies are often made on a mogul, where the heated starch mixture is dripped into molds, cooled and dehydrated after demolding. These cooking conditions make a product that is typically very tough tooth-sticking texture without elasticity (e.g., Swedish Fish, Sour Patch Kids).

Trials were conducted evaluating numerous production methods and the methods which utilized heat, mechanical stress, and pressure surprisingly and substantially improved the texture and chew of the product, producing a soft and bouncy candy with long elastic chew. The long term (between about 3 to about 6 months) staling trials demonstrated decreased retrogradation or staling. In addition to heat, pressure improves hydration of the starch granules, while mechanical shear improves starch granule disruption. Thus, both pressure and shear increase the disorder of the starch molecule, leading to improved gelatinization and decreased retrogradation.

In one embodiment, % Retrogradation can be measured by Differential scanning calorimetry (DSC) as indicated below. Typical retrogradation rates after 2 weeks are 30-40% for unmodified starch. For modified starches, the retrogradation rates are less than 20%. The modified starches may be close to typical for unmodified starches and the retrogradation rates are between about 25% and about 35%.

Retrogradation continues to increase over time and is affected by the amount of initial gelatinization and well as other ingredients present, which can inhibit the retrogradation. So retrogradation would continue to increase if measured monthly over the shelf life of a starch candy food product.

Other ways to measure retrogradation include the following:
1) When examining the gelatinization processes by temperature scanning calorimetric measurements (e.g., DSC), up to 4 thermal transitions can be observed depending on the water content and final heating temperature (Goldstein and others 2010; Randzio and others 2002):
2) A single endotherm, generally referred to as the G endotherm, occurring at ˜60-70° C. in excess water (usually >50% wet basis). This endotherm, if present, occurs at constant temperature regardless of the amount of water present in the system. The enthalpy change increases with increasing water content.
3) A second endothermic peak, commonly called the M1 endotherm, may partially overlap the G endotherm and is observed at higher temperatures as the starch to water ratio increases. As water content is sufficiently increased, the G and M1 endotherm converge, resulting in a single endothermic peak as previously described.
4) As water content further decreases, the G endotherm disappears, and the M1 endotherm shifts to higher temperatures.
5) Two transitions, occurring at temperatures higher than the G and M1 endotherms have also been observed and are typically linked to the melting of amylose and amylose-lipid complexes.

In one embodiment, a thick paste with the modified starches shows no retrogradation and compare mochi gummy candy showing retrogradation.

Differential scanning calorimetry (DSC) is a thermoanalytical technique in which the difference in the amount of heat required to increase the temperature of a sample and reference is measured as a function of temperature. DSC can measure retrogradation includes the following steps: 3.7 mg of starch (or mochi dry mix) weighed into 25 ul aluminum pans; add distilled water added at a ratio 3:1; sealed pan set overnight at room temperature; heat in DSC from 25° C. to 100° C. at a rate of 10° C./min; and % retrogradation calculated as the ratio of enthalpy of gelatinization to enthalpy of retrogradation.

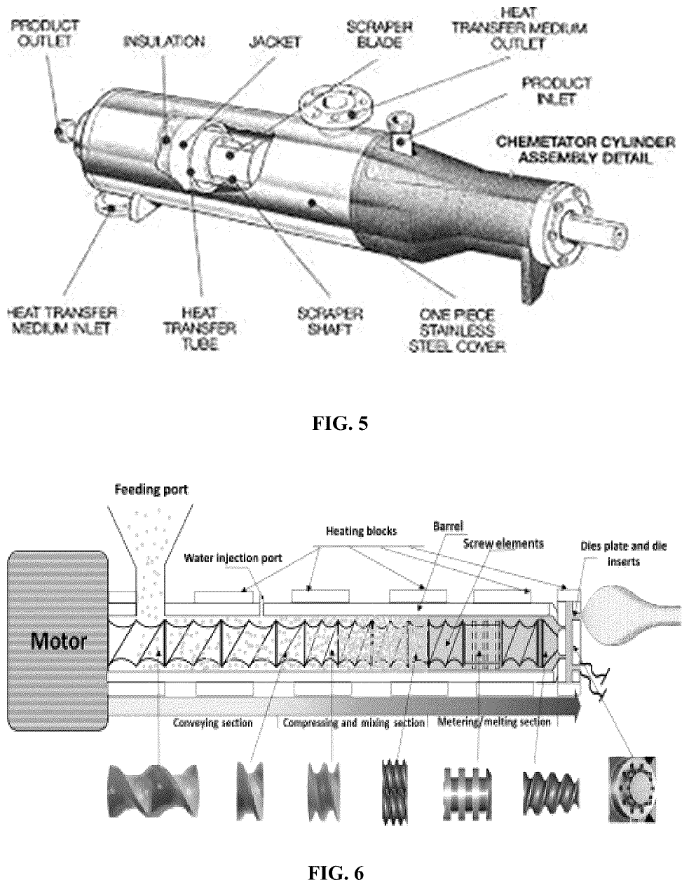

Mechanical stress and pressure can be added to the manufacturing system through the use of: A pressurized scraped surface heat exchanger (FIG. 5), or single or twin-screw cooking extruder (FIG. 6).

Manufacturing Process may include some or all of the following steps: 1) Use of starch combinations (modified vs. unmodified rice, tapioca, taro, arrowroot, corn, and potato) and polyols to achieve desired texture, chew and shelf-stability. 2) Add all ingredients including: starches, polyols, saccharides, water, etc. 3) Temperature cooking from 160 C to 260 C. 4) Mechanical stress and pressure (0-10 bars) applied by scraped surface heat exchanger or single/twin screw cooker extruder. 5) Introduce acids and buffers (weak acids) such as but not limited to citric acid, malic acid, cultured dextrose, and cultured brown rice to enhance flavor and achieve target pH between about 2.5 to about 6.8 to inhibit bacterial/fungal growth.

Embodiments of the method and formulation include a starch-based (e.g., rice, tapioca, taro, arrowroot, corn, and potato) confectionary food product (gummy candy) shaped into a cube or sphere (or may take another preferred shape), with a soft and elastic chew throughout. It may include glycerin at percentages by weight between about 0.1 to about 15%. It may be flavored and colored using artificial or natural flavors and colors. Acids such as citric acid, malic acid, cultured dextrose, and cultured brown rice among others may be used both to enhance flavor and to achieve a target pH in the about 2.5 to about 6.8 range to inhibit mold production.

Certain embodiments of the method and formulation include the following: 1) Rice ingredients: Rice starch, rice flour, glutinous rice flour, and modified rice starch. 2) Tapioca ingredients: Tapioca flour, tapioca starch, and modified tapioca starch. 3) Polyols: glycerin, sorbitol, erythritol, xylitol, and mannitol. 4) Monosaccharides, disaccharides, oligosaccharides, polysaccharides: glucose, fructose, allulose, sucrose, dextrose, brown sugar, soluble corn fiber, soluble tapioca fiber, polydextrose, polyol syrups, corn syrup, tapioca syrup, and glucose syrups. 5) Flavoring including natural and artificial flavors. 6) Coloring including natural and artificial colors. 7) Acids: Citric acid, malic acid, cultured dextrose, and cultured brown rice.

Certain embodiments of the method and formulation comprise the following characteristics: 1) Aw ranges: 0.5-0.8; 2) Brix ranges: 72-89; 3) pH ranges 2.5-6.8.

Certain embodiments of the method and formulation comprise the following formulations (although not all ingredients may be included in some further embodiments) based upon weight percentages:

### Tapioca-Based Formulation

| | |
|---|---|
| Modified tapioca starch | between about 5 to about 40% |
| Tapioca flour | between about 5 to about 40% |
| Glycerine (or other polyol) | between about 0.1 to about 15% |
| Tapioca or glucose syrup | between about 10 to about 50% |
| Sugar (Cane or other) | between about 10 to about 50% |
| Invert sugar | between about 10 to about 50% |
| Flavoring | between about 0.5 to about 10% |
| Coloring | between about 0.5 to about 10% |
| Acid | between about 0.1 to about 5% |
| Water | between about 5 to about 30% |
| Other ingredients | between about 1 to about 30% |

### Rice Based Formulation

| | |
|---|---|
| Modified Rice Starch | between about 5 to about 40% |
| Rice Starch | between about 5 to about 40% |
| Glycerine (or other polyol) | between about 0.1 to about 15% |
| Tapioca or glucose syrup | between about 10 to about 50% |
| Sugar (Cane or other) | between about 10 to about 50% |
| Invert sugar | between about 10 to about 50% |
| Flavoring | between about 0.5 to about 10% |
| Coloring | between about 0.5 to about 10% |
| Acid | between about 0.1 to about 5% |
| Water | between about 5 to about 30% |
| Other ingredients | between about 1 to about 30% |

### Tapioca and Rice-Based Formulation

| | |
|---|---|
| Modified tapioca starch | between about 5 to about 40% |
| Tapioca flour | between about 5 to about 40% |
| Modified Rice Starch | between about 5 to about 40% |
| Rice Starch | between about 5 to about 40% |
| Glycerine (or other polyol) | between about 0.1 to about 15% |
| Tapioca or glucose syrup | between about 10 to about 50% |
| Sugar (Cane or other) | between about 10 to about 50% |
| Invert sugar | between about 10 to about 50% |
| Flavoring | between about 0.5 to about 10% |
| Coloring | between about 0.5 to about 10% |
| Acid | between about 0.1 to about 5% |
| Water | between about 5 to about 30% |
| Other ingredients | between about 1 to about 30% |

### Mixed Starch Based Formulation

| | |
|---|---|
| Modified starch (rice, tapioca, taro, | between about 5 to about 40% |
| arrowroot, corn or potato) | |
| Unmodified starch (rice, tapioca, | between about 5 to about 40% |
| taro, arrowroot, corn or potato) | |
| Glycerine (or other polyol) | between about 0.1 to about 15% |
| Tapioca or glucose syrup | between about 10 to about 50% |
| Sugar (Cane or other) | between about 10 to about 50% |
| Invert sugar | between about 10 to about 50% |
| Flavoring | between about 0.5 to about 10% |
| Coloring | between about 0.5 to about 10% |
| Acid | between about 0.1 to about 5% |
| Water | between about 5 to about 30% |
| Other ingredients | between about 1 to about 30% |

### Sugar Free Tapioca-Based Polyol Formulation

| | |
|---|---|
| Modified tapioca starch | between about 5 to about 40% |
| Tapioca flour | between about 5 to about 40% |
| Polyol syrup | between about 5 to about 40% |
| Flavoring | between about 0.5 to about 10% |
| Coloring | between about 0.5 to about 10% |
| Acid | between about 0.1 to about 5% |
| Water | between about 5 to about 30% |
| Other ingredients | between about 1 to about 30% |

### Sugar Free Rice-Based Polyol Formulation

| | |
|---|---|
| Modified Rice Starch | between about 5 to about 40% |
| Rice Starch | between about 5 to about 40% |
| Polyol syrup | between about 5 to about 40% |
| Flavoring | between about 0.5 to about 10% |
| Coloring | between about 0.5 to about 10% |
| Acid | between about 0.1 to about 5% |
| Water | between about 5 to about 30% |
| Other ingredients | between about 1 to about 30% |

### Sugar Free Mixed Starch Polyol Formulation

| | |
|---|---|
| Modified starch (rice, tapioca, taro, | between about 5 to about 40% |
| arrowroot, corn or potato) | |
| Unmodified starch (rice, tapioca, | between about 5 to about 40% |
| taro, arrowroot, corn or potato) | |
| Polyol syrup | between about 5 to about 40% |
| Flavoring | between about 0.5 to about 10% |
| Coloring | between about 0.5 to about 10% |
| Acid | between about 0.1 to about 5% |
| Water | between about 5 to about 30% |
| Other ingredients | between about 1 to about 30% |

### Low Sugar, Allulose and Fiber Tapioca-Based Formulation

| | |
|---|---|
| Modified tapioca starch | between about 5 to about 40% |
| Tapioca flour | between about 5 to about 40% |
| Glycerine (or other polyol) | between about 0.1-20% |
| Tapioca or glucose syrup | between about 5 to about 20% |
| Allulose | between about 5 to about 20% |
| Soluble Fiber | between about 5 to about 50% |
| Flavoring | between about 0.5 to about 10% |
| Coloring | between about 0.5 to about 10% |
| Acid | between about 0.1 to about 5% |
| Water | between about 5 to about 30% |
| Other ingredients | between about 1 to about 30% |

### Boba Formulation

| | |
|---|---|
| Modified tapioca starch | between about 5 to about 40% |
| Tapioca flour | between about 5 to about 40% |
| Glycerine (or other polyol) | between about 0.1 to about 15% |
| Brown sugar | between about 2 to about 20% |
| Tapioca or glucose syrup | between about 2 to about 20% |
| Flavoring | between about 0.5 to about 10% |
| Coloring | between about 0.5 to about 10% |
| Acid | between about 0.1 to about 5% |
| Water | between about 5 to about 30% |
| Other ingredients | between about 1 to about 30% |

### Tapioca-Based High Protein Formulation

| | |
|---|---|
| Modified tapioca starch | between about 5 to about 40% |
| Tapioca flour | between about 5 to about 40% |
| Glycerine (or other polyol) | between about 0.1 to about 15% |
| Tapioca or glucose syrup | between about 10 to about 50% |
| Sugar (Cane or other) | between about 10 to about 50% |
| Invert sugar | between about 10 to about 50% |
| Proteins (whey, casein, | between about 10 to about 30% |
| pea, soy, rice, chickpea) | |
| Flavoring | between about 0.5 to about 10% |
| Coloring | between about 0.5 to about 10% |
| Acid | between about 0.1 to about 5% |
| Water | between about 5 to about 30% |
| Other ingredients | between about 1 to about 30% |

### Rice-Based High Protein Formulation

| | |
|---|---|
| Modified Rice Starch | between about 5 to about 40% |
| Rice Starch | between about 5 to about 40% |
| Glycerine (or other polyol) | between about 0.1 to about 15% |
| Tapioca or glucose syrup | between about 10 to about 50% |
| Sugar (Cane or other) | between about 10 to about 50% |
| Invert sugar | between about 10 to about 50% |
| Proteins (whey, casein, | between about 10 to about 30% |
| pea, soy, rice, chickpea) | |
| Flavoring | between about 0.5 to about 10% |
| Coloring | between about 0.5 to about 10% |
| Acid | between about 0.1 to about 5% |
| Water | between about 5 to about 30% |
| Other ingredients | between about 1 to about 30% |

### Tapioca and Rice-Based High Protein Formulation

| | |
|---|---|
| Modified tapioca starch | between about 5 to about 40% |
| Tapioca flour | between about 5 to about 40% |
| Modified Rice Starch | between about 5 to about 40% |
| Rice Starch | between about 5 to about 40% |
| Glycerine (or other polyol) | between about 0.1 to about 15% |
| Tapioca or glucose syrup | between about 10 to about 50% |
| Sugar (Cane or other) | between about 10 to about 50% |
| Invert sugar | between about 10 to about 50% |
| Proteins (whey, casein, | between about 10 to about 30% |
| pea, soy, rice, chickpea) | |
| Flavoring | between about 0.5 to about 10% |
| Coloring | between about 0.5 to about 10% |
| Acid | between about 0.1 to about 5% |
| Water | between about 5 to about 30% |
| Other ingredients | between about 1 to about 30% |
| Water | between about 5 to about 30% |
| Other ingredients | between about 1 to about 30% |

### Mixed Starch Based High Protein Formulation

| | |
|---|---|
| Modified starch (rice, tapioca, taro, | between about 5 to about 40% |
| arrowroot, corn or potato) | |
| Unmodified starch (rice, tapioca, taro, | between about 5 to about 40% |
| arrowroot, corn or potato) | |
| Glycerine (or other polyol) | between about 0.1 to about 15% |
| Tapioca or glucose syrup | between about 10 to about 50% |
| Sugar (Cane or other) | between about 10 to about 50% |
| Invert sugar | between about 10 to about 50% |
| Proteins (whey, casein, | between about 10 to about 30% |
| pea, soy, rice, chickpea) | |
| Flavoring | between about 0.5 to about 10% |
| Coloring | between about 0.5 to about 10% |
| Acid | between about 0.1 to about 5% |
| Water | between about 5 to about 30% |
| Other ingredients | between about 1 to about 30% |

### Examples

The previous examples are put forth so as to provide those of ordinary skill in the art with a complete disclosure and description of how the compounds, compositions, articles, devices and/or methods claimed herein are made and evaluated and are intended to be purely exemplary of the invention and are not intended to limit the scope of what the inventors regard as their invention. However, those of skill in the art should, in light of the present disclosure, appreciate that many changes can be made in the specific embodiments which are disclosed and still obtain a like or similar result without departing from the spirit and scope of the invention.

Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

### REFERENCES

[1] www.accessdata.fda.gov. Code of Federal Regulations Title 21, Volume 3, Cite: 21CFR1821320.
[2] Potential of Starch Nanocomposites for Biomedical Applications. Zakaria N H, et al. IOP Conf. Series: materials Science and Engineering 209 (2017).
[3] https://pubchem.ncbi.nlm.nih.gov/compound/Glycerin
[4] Starch gelatinization and its complexity for analysis. Schirmer M, Jekle M, Becker T. Starch 2015. 67 30-41.
[5] Adsorption of Azo dyes on Polymer Materials. VV Panic et al. Hem. Ind. 67 (6) 881-900 (2013).
[6] National Center for Biotechnology Information. PubChem Compound Summary for CID 5780, Sorbitol. https://pubchem.ncbi.nlm.nih.gov/compound/Sorbitol. Accessed Mar. 24, 2024.
[7] National Center for Biotechnology Information. PubChem Compound Summary for CID 222285, Erythritol. https://pubchem.ncbi.nlm.nih.gov/compound/Erythritol. Accessed Mar. 24, 2024.
[8] National Center for Biotechnology Information. PubChem Compound Summary for CID 6912, Xylitol. https://pubchem.ncbi.nlm.nih.gov/compound/Xylitol. Accessed Mar. 24, 2024.
[9] National Center for Biotechnology Information. PubChem Compound Summary for CID 6251, Mannitol. https://pubchem.ncbi.nlm.nih.gov/compound/Mannitol. Accessed Mar. 24, 2024.
[10] Analysis of heat flow and “channelling” in a scraped-surface heat exchanger. Fitt A et al. Journal of Engineering Mathematics 57 (4): 407-422.
[10] Extrusion Cooking (Second Edition). Chapter 1-Basics of Extrusion Processing. Ek P and G Ganjyal. 2020. 1-28.

All publications and patent applications mentioned in this specification are herein incorporated by reference to the same extent as if each individual publication or patent application was specifically and individually indicated to be incorporated by reference.

While the invention has been described in connection with various embodiments, it will be understood that the invention is capable of further modifications. This application is intended to cover any variations, uses or adaptations of the invention following, in general, the principles of the invention, and including such departures from the present disclosure as, within the known and customary practice within the art to which the invention pertains.

What is claimed is:

1. A method of creating and preserving a unique texture and chewiness of starch-based chewy candy comprising: using polyol molecules to improve starch gelatinization of the starch-based chewy candy and decreasing the starch retrogradation to produce a shelf-stable food product with a soft and chewy texture.

2. The method of claim 1, wherein the polyol molecule is a glycerin, sorbitol, erythritol, xylitol, mannitol, or other polyol molecules.

3. The method of claim 2, wherein the polyol molecule(s) are used between about 0.1 to about 15% of the food product by weight.

4. The method of claim 3, wherein the food product comprises: a polyol or polyol molecules, modified or unmodified starch or starches, and a sweetener blend.

5. The method in claim 4, where the sweetener blend is a monosaccharides, disaccharides, oligosaccharides, polysaccharides or syrup including but not limited to: glucose, fructose, allulose, sucrose, dextrose, sorbitol, brown sugar, soluble corn fiber, soluble tapioca fiber, polydextrose, rice syrup, corn syrup, tapioca syrup, potato syrup, agave syrup, isomaltooligosaccharide syrup, maltose syrup, glucose syrup, invert syrup, and combinations thereof.

6. The method of claim 5, wherein the sweetener blend is used between 30-80% of the food product by weight.

7. A method of creating and preserving a unique texture and chewiness of starch-based chewy candy comprising: the use of starch combinations to improve shelf-life, texture and chew of the food product.

8. The method of claim 7, wherein the starch combinations are modified and unmodified starches from the sources including but not limited to: rice, tapioca, arrowroot, corn, potato, and taro.

9. The method of claim 8, wherein the starch combinations are used between about 5 to about 40% of the food product by weight.

10. The method of claim 9, wherein the food product exhibits a water activity between about 0.5 and about 0.79, the brix reads between about 72 and about 89, and pH ranges between about 2.5 to about 4.0.

11. A method of making a shelf-stable soft and chewy food product, comprising: using a combination of heat, pressure and mechanical stress to improve the texture, chew and shelf life of the soft and chewy food product.

12. The method of claim 11, wherein using high pressure extrusion cooking with a temperature between about 120° C. to about 160° C., a pressure between about 0 to about 10 bars of pressure and mechanical stress.

13. The method of claim 11, further comprising using a pressurized scraped surface heat exchanger and a single or twin-screw cooking extruder.

14. The method of claim 1, wherein the food product is covered in chocolate or other fat-based coating.

15. The method of claim 1, wherein the food product includes protein powder selected from the group consisting of whey, collagen, or plant powder including whey, casein, pea, soy, rice, chickpea.

16. The method of claim 7, wherein the food product is covered in chocolate or other fat-based coating.

17. The method of claim 1, where the food product includes protein powder selected from the group consisting of whey, collagen, or plant powder including whey, casein, pea, soy, rice, chickpea.
